(19) United States
(12) Patent Application Publication
(10) Pub. No.: US 2017/0372305 A1
(43) Pub. Date: Dec. 28, 2017

(54) METHOD AND SYSTEM TO ACTIVATE A MODE OF A SERVICE STATION

(71) Applicant: MasterCard Asia/Pacific Pte. Ltd., Singapore (SG)

(72) Inventors: Jiaming Li, Singapore (SG); Xijing Wang, Singapore (SG); Jie Zhang, Singapore (SG)

(21) Appl. No.: 15/626,394

(22) Filed: Jun. 19, 2017

(30) Foreign Application Priority Data
Jun. 22, 2016 (SG) 10201605153X

(51) Int. Cl. G06Q 20/38; G06Q 20/40; G06Q 20/32

(52) U.S. Cl. CPC G06Q 20/382; G06Q 20/327; G06Q 20/401

(57) ABSTRACT

There is provided a data processor implemented method and system for making payment to activate a mode of a service station. The method and system are enabled through use of service and payment tokens.

### FIELD OF INVENTION

Embodiments of the present invention relate to a method and system to activate a mode of a service station.

### BACKGROUND

Provision of short-term accommodation (by hotels and accommodation facilitators like Airbnb™) has traditionally been charged on a per-day basis. The chargeable rate typically remains constant regardless of the amount of electricity consumed by the customer during their stay. In order to increase revenue and encourage more efficient use of electricity in their premises, it would also be desirable to be able to introduce some control of the usage of electrical appliances provided in the room for the guest by charging guests for their usage of those appliances.

In addition, self-service machine manufacturers such as manufacturers of commercial washing machines and dryers, event or gymnasium lockers, or parking ticket machines typically provide for payment by coin or credit card, particularly machines which have been in use or conceived before smartphones were popular. If one did not have the correct denomination of coins, sufficient money or a credit card then payment and use of the self-service machine may not be possible. This leads to inconvenience for the consumer and loss of business for the machine operator/owner. It would be desirable to allow the consumer to use a self-service machine without requiring coins or a physical credit card to be presented to the machine.

It is also generally desirable to improve consumer experiences with making payments for goods and services.

### SUMMARY

In a first aspect, there is provided a data processor implemented method for making payment to activate a mode of a service station, the method including, in one or more electronic processing devices: providing, to a user device, a service token, the service token being at least one of: indicative of one or more pre-determined payment options associated with a plurality of activation modes of the service station, and associated with a service session established between the user device and the service station; providing, from the user device, the service token to a payment system via a communications network; receiving, from the payment system, an indication of the payment options associated with the service token; providing, from the user device, payment information to the payment system in accordance with a payment option selected by the user; receiving, at the user device, a payment token from the payment system in response to successful payment using the payment information; receiving, from the user device, the payment token; and, using the payment token to activate the mode of the service station in accordance with the payment option selected by the user.

Preferably, each of the plurality of activation modes is a different payment quantum.

It is preferable that the one or more electronic processing devices communicates with the user device via a wireless communications protocol, the wireless communications protocol including Bluetooth™ Low Energy (BLE) protocol.

The method can further include validating the payment token using a device identifier.

It is preferable that the step of validating the payment token includes at least one of: decrypting the payment token using a unique key; using the device identifier to determine that the payment token has been received for an intended service station; verifying a digital signature generated by the payment system for the intended service station; determining that the payment token is for the established service session between the user device and the intended service station; and determining that the payment option selected by the user is valid for the intended service station.

There is also provided a system for making payment to activate a mode of a service station, the system including one or more electronic processing devices that: provides, to a user device, a service token, the service token being at least one of: indicative of one or more pre-determined payment options associated with a plurality of activation modes of the service station, and associated with a service session established between the user device and the service station; provides, from the user device, the service token to a payment system via a communications network; receives, from the payment system, an indication of the payment options associated with the service token; provides, from the user device, payment information to the payment system in accordance with a payment option selected by the user; receives, at the user device, a payment token from the payment system in response to successful payment using the payment information; receives, from the user device, the payment token; and, uses the payment token to activate the mode of the service station in accordance with the payment option selected by the user.

It is preferable that each of the plurality of activation modes is a different payment quantum.

Preferably, the one or more electronic processing devices communicates with the user device via a wireless communications protocol, the wireless communications protocol including Bluetooth™ Low Energy (BLE) protocol. The one or more electronic processing devices can also validate the payment token using a device identifier.

Preferably, the validation of the payment token includes at least one of: decryption of the payment token using a unique key; use of the device identifier to determine that the payment token has been received for an intended service station; verification of a digital signature generated by the payment system for the intended service station; determination that the payment token is for the established service session between the user device and the intended service station; and determination of the payment option selected by the user is valid for the intended service station.

There is also provided a non-transitory computer readable storage medium embodying thereon a program of computer readable instructions which, when executed by one or more processors of a user device in communication with at least one payment system and an authentication device, cause the user device to perform a method for making payment to activate a mode of a service station, the method embodying the steps of: providing, to the user device, a service token, the service token being at least one of: indicative of one or more pre-determined payment options associated with a plurality of activation modes of the service station, and associated with a service session established between the user device and the service station; providing, from the user device, the service token to a payment system via a communications network; receiving, from the payment system, an indication of the payment options associated with the service token; providing, from the user device, payment information to the payment system in accordance with a payment option selected by the user; receiving, at the user device, a payment token from the payment system in response to successful payment using the payment information; providing, from the user device, the payment token; and, using the payment token to activate the mode of the service station in accordance with the payment option selected by the user.

It is preferable that each of the plurality of activation modes is a different payment quantum. The one or more electronic processing devices can communicate with the user device via a wireless communications protocol, the wireless communications protocol including Bluetooth™ Low Energy (BLE) protocol.

The storage medium can preferably be further embodied in a step of validating the payment token using a device identifier.

Preferably, the step of validating the payment token includes at least one of: decrypting the payment token using a unique key; using the device identifier to determine that the payment token has been received for an intended service station; verifying a digital signature generated by the payment system for the intended service station; determining that the payment token is for the established service session between the user device and the intended service station; and determining that the payment option selected by the user is valid for the intended service station.

### DESCRIPTION OF FIGURES

In order that the present invention may be fully understood and readily put into practical effect, there shall now be described by way of non-limitative example only, certain embodiments of the present invention, the description being with reference to the accompanying illustrative figures, in which:

FIG. 1 is a flow chart of an example of a method of activating a mode of a service station;

FIG. 2 is a schematic diagram of an example of a system for activating a mode of a service station;

FIG. 3 is a schematic diagram showing components of an example user device of the system shown in FIG. 2;

FIG. 4 is a schematic diagram showing components of an example payment processing device of the system shown in FIG. 2; and

FIGS. 5A to 5C is a flowchart of a specific example of a method of activating a mode of a service station.

### DETAILED DESCRIPTION

There is provided a method, and system for making payment to activate a mode of a service station. In at least some embodiments, the method, and system allow users to activate a mode of a service station where in the past, there would be issues doing so, due to for example, lack of change, lack of credit card, and so forth. In addition, the method, and system may lead to enhanced revenues at the service stations as well as improved user experiences when making payments at service stations.

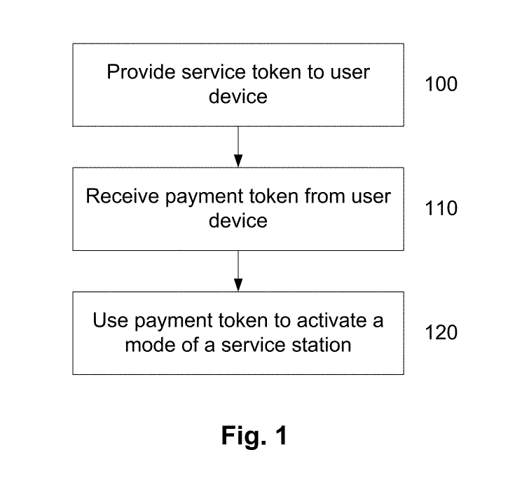

An example of a method for making payment to activate a mode of a service station will now be described with reference to FIG. 1.

For the purpose of illustration, it is assumed that the method is performed at least in part using one or more electronic processing devices such as a suitably programmed microcontroller forming part of an authentication device and in communication with one or more user devices, such as mobile phones, portable computers, tablet computers, or the like. The user devices are also typically in communication with a payment system which may comprise any suitable computer system such as a server that is capable of processing payments made by the user and which may include a number of processing devices associated with each of an issuer, acquirer, card network and payment gateway, or alternatively, the payment processing system may include any one or more of these entities and this will be discussed further below.

The term service station is intended to cover any electrical device that consumes power and will typically refer to consumer appliances such as washing machines, dryers, phone or battery chargers, televisions, lamps, fridges, dishwashers, heaters and the like, although commercial machines such as vending machines, ticketing machines, parking meters and the like may also be included.

In this example, at step 100 the one or more electronic processing devices provide a service token to a user device, the service token being indicative of one or more pre-selected payment options associated with activating a mode of the service station, and/or also associated with a service session established between the user device and the service station. The payment options associated with a particular appliance will typically have been pre-selected by a merchant who may be the manufacturer or operator/owner of the service station. The payment options will typically be of different payment quantums specific for the service station and the functionality that it provides. For example, a washing machine or dishwasher may provide multiple payment options for particular wash cycles or durations whilst a phone charger may simply provide a single payment option to fully charge a mobile phone. Whilst typically a user will pay to power an appliance for a given period of time, in alternative examples, the user may pay for a pre-determined amount of power or pay for the use of the appliance for a specific purpose such as charging a phone (which would not necessarily be based on time).

Typically, the one or more electronic processing devices communicate with the user device to provide the service token via a wireless communications protocol such as Bluetooth, Zigbee, Wi-fi and the like. In one example, the authentication device includes a wireless transceiver such as a Bluetooth™ Low Energy (BLE) module. In one example, the electronic processing device is configured to provide a wireless hotspot to which the user device may be connected or paired. When the user comes within a certain vicinity of the authentication device they will be able to connect or pair with the authentication device in order to establish communication therewith.

Having received the service token, the user device is typically responsive to provide the service token to a payment system via a communications network. The payment system is able to interpret the service token to determine the payment options that are associated with the service token for the specific service station. This information will have previously been provided to the payment system from the merchant/owner/operator when configuring the authentication device before use, as will be described in more detail below.

The user device then receives from the payment system an indication of the payment options associated with the service token. For example, the payment system may cause a user interface such as payment webpage to be displayed on the user device which provides a representation of the payment options (such as $1.00 for 3 minutes, $2.00 for 6 minutes and so forth). The user then selects a desired payment option for example by clicking on a button indicative of the payment option and proceeds to checkout to pay for the use of the service station. In this way, the user provides payment information to the payment system in accordance with the payment option selected by the user. The transaction may then be processed in a similar way to which a standard e-commerce transaction is performed with a merchant/owner/operator. In response to successful payment using the provided payment information, the user device then receives a payment token from the payment system.

At step 110, the one or more electronic processing devices then receive the payment token from the user device. In this regard, the same wireless communication protocol previously described is used by the user device to send the payment token to the authentication device. In this regard, after receiving the payment token from the payment system, the user may be prompted through a user interface or via a message to send the payment token to the authentication device.

At step 120, the one or more electronic processing devices then use the payment token to control the service station at least partially in accordance with the payment option selected by the user. In this regard, the payment token will be indicative of the payment option selected by the user and the authentication device will be able to interpret the payment token to control the service station in accordance with the selected payment option as will be described in further detail below.

Thus, once the payment token has been received, the authentication device can cause the service station to operate in a desired manner (mode). In this regard, it will be appreciated that the authentication device can be located between a power supply and the service station such that the authentication device is operable to cause the service station to operate in a desired manner (mode). As will be described in more detail later, in one example the authentication device forms parts of or comprises an adaptor which may be located between a power outlet and the service station. Alternatively, the authentication device may be embedded into the power outlet such than the service station can be plugged directly into a wall outlet for example, or could be incorporated into the service station.

The above described method and apparatus provides a number of advantages.

Firstly, the method enables the service station to be used on a ‘pay per use’ basis without requiring any physical coins, bank notes banks cards to be presented for payment. This overcomes many of the drawbacks of using commercial self-service machines such as washing machines and dryers which typically require specific denominations of coins for use that a user might not always have. This simplicity of payment may therefore lead to increased uptake and use of such machines leading to increased sales and profitability for machine owners/operators.

Enabling service stations to be operated on a ‘pay per use’ basis also provides accommodation suppliers such as hotels and Airbnb™ room owners the opportunity to create an additional revenue stream from use of appliances provided in their rooms for the use of guests.

Furthermore, ‘pay per use’ service stations may assist in reducing energy usage by encouraging users to become more conscious of the amount of electricity that they use, particularly when they learn to correlate use of a service station with a specific cost. This may be more readily achieved by paying each time a service station is used rather than paying an overall energy bill for a property on a periodic basis such as monthly/bi-monthly/quarterly as is typically the case at present.

A number of further features will now be described.

As previously mentioned the one or more payment options may be associated with various parameters. In one example, the payment options are associated with providing power to the service station for a pre-determined amount of time. In this example the user pays for use of the service station for a certain duration of time, typically defined in minutes or hours of usage (e.g. $1.00 to park a vehicle for 5 minutes, $2.00 to park a vehicle for 10 minutes). In another example, the payment options are associated with payment quantums (e.g. $1.50 for a type A canned drink, $3.00 for a type B canned drink). In yet a further example, the payment options are associated with providing an amount of power to the service station in accordance with an electrical parameter of the service station. For example, an electrical parameter could be the state of charge of a battery and the user pays to fully charge the battery which may be associated with a mobile phone or computer for example. The state of charge may be monitored directly or inferred based on a different parameter such as the current drawn by the service station for example.

In one example, the one or more electronic processing devices communicate with the user device via a wireless communication protocol as previously mentioned. In one example, the wireless communications protocol includes Bluetooth™ Low Energy (BLE) protocol however any other suitable protocol or form of wireless communication may be used including Wi-Fi, Zigbee or Near Field Communication (NFC).

Typically, the one or more electronic processing devices validate the payment token using a device identifier. The validation step typically occurs after the authentication device has received the payment token from the user device and prior to initiating control of the service station to operate the service station in a desired manner (mode).

The step of validating the payment token using the device identifier may include a number of aspects. For instance, the payment token generated by the payment system may be encrypted using a key derived from or associated with the device identifier. In this case, part of the validation step would include decrypting the payment token using the key derived from or associated with the device identifier. In this way, the device identifier may be used to determine that the payment token has been received by the intended authentication device, as well as to ensure the payment token is a legitimate payment token generated by the payment system. A further validation step may include determining that the payment option selected by the user (and associated with the payment token) is valid for the particular service station. The step of validating the payment token may therefore ensure that the payment token has not been inadvertently sent or received by an incorrect service station, and that a payment option that is actually provided is desired by the user.

Typically, before the authentication device is ready to be used by a user, it is set up by a merchant/owner/operator in order to provide the pre-selected payment options. The payment options can be stored at the authentication device only, a remote server only, or both the remote server and a merchant device. In this regard, the one or more electronic processing devices typically communicate with the merchant device via a wireless communications protocol in order to pre-configure the authentication device prior to use by the user. The authentication device may communicate with the merchant device via any of the wireless communications protocols previously discussed that may be used to communicate with the user device. It is also possible for the authentication device to be configured for wired communications using protocols such as, for example, Ethernet, serial, I2C, UART, SPI and so forth. The authentication device can be coupled to a merchant-dependent secondary device which enables the wired communications, such as, for example, an SD card with a secure element, a personalized smart card, and so forth.

An example of a merchant configuration process shall now be described. In this example, the one or more electronic processing devices firstly generate an initialization data packet. The initialization data packet is generated based on the device identifier such as a unique device key or a shared secret data packet assigned to the authentication device by the manufacturer. The initialization data packet is provided to the merchant device in order to configure the authentication device with one or more merchant selected payment options. The merchant device is responsive to the initialization data packet to register the initialization data packet with the one or more payment options associated with providing electrical power to the service station (for example $1.00 for 3 minutes, $2.00 for 6 minutes). In one example, this step may be performed using a merchant application executing on the merchant device or via any other suitable interface that allows the merchant to associate payment options with the initialization data packet.

The merchant device then provides the registered initialization data packet to a payment system, the payment system responsive to generate provisioning data for use in controlling the authentication device as will be described in further detail below. The merchant device receives the provisioning data from the payment system and in turn sends the provisioning data to the authentication device. The authentication device receives the provisioning data and stores it in a data store forming part of the authentication device. The provisioning data is used by the authentication device to configure the authentication device, so that the authentication device can at least partially control the service station in accordance with the payment option selected by the user.

As previously mentioned, the initialization data packet is generated using a device identifier associated with the authentication device. The device identifier is typically stored in at least one of a local data store and a remote data store (for example associated with the payment system). The local data store typically forms part of the authentication device. The remote data store is remote to the authentication device and may be in communication with the one or more electronic processing devices via a communications network.

The provisioning data for use in controlling the switch typically includes at least one of a merchant identifier associated with the merchant/owner/operator, a device identifier associated with the authentication device, an indication of the payment options provided by the merchant associated with providing electrical power to the service station, and instructions for use in controlling the service station in accordance with the payment options. The provisioning data therefore comprises software and/or firmware that is permanently programmed into the read-only memory of the authentication device in accordance with the payment options provided by the merchant/owner/operator.

In one example, the one or more electronic processing devices validate the provisioning data prior to storage in the data store. For example, the validation process may include determining that the device key associated with the provisioning data matches the device key of the authentication device to which the provisioning data has been sent. This can be achieved in any suitable manner, such as through encryption of the provisioning data using the device identifier, in a manner similar to that described above with respect to the payment token. Furthermore, the validation process may check whether a valid merchant identifier has been provided to ensure that payment for use of service stations connected to the authentication device are routed to the appropriate merchant/owner/operator.

It is to be appreciated that the above described method is performed by one or more electronic processing devices forming part of an authentication apparatus. The apparatus further includes a wireless transceiver module and wherein the one or more electronic processing devices communicate with the user device (and merchant device) via the wireless transceiver module. In a specific form, the wireless transceiver module is a Bluetooth™ Low Energy (BLE) transceiver module, although it need not be limited to such and could include any suitable wireless transceiver. The apparatus may further include a local data store as previously described for storing the provisioning data, device identifier etc.

The above components of the apparatus can be housed within a housing that can include a plug for releasable engagement to a wall mounted electrical power outlet, and a socket for receiving an electrical plug associated with the service station. Alternatively, the apparatus may include a switch housing adapted for securement to a wall mounted electrical power outlet. It is to be understood therefore that the apparatus could form either an adaptor that plugs into a wall socket or it may be embedded into the wall socket or power outlet. In either case, the apparatus is capable of providing an interface between an electrical power supply and an appliance. Whilst typically the power supply will be a mains electricity supply, in some examples the power supply may be from a battery or other form of energy storage. The apparatus can also be integrated with the service station in a manner such that the apparatus is communicatively coupled to a controller of the service station and is able to control the service station.

In one example, a user application is provided on the user device for use in controlling the authentication device to control the service station in a desired mode. The user device typically includes one or more electronic processing devices to receive a service token from the authentication device, the service token being indicative of one or more pre-selected payment options associated with providing power to the service station. The user device then provides the service token to a payment system via a communications network and receives from the payment system an indication of the payment options associated with the service token. The user then selects a payment option via the application which thereby receives an indication of a payment option selected by the user. The payment information is then provided to the payment system in accordance with the payment option selected by the user and the user device receives a payment token from the payment system in response to successful payment using the provided payment information. Finally, the user processing device provides the payment token to the authentication device, the authentication device responsive to the payment token to control the service station in accordance with the selected payment option. The authentication device validates the payment token using a unique key.

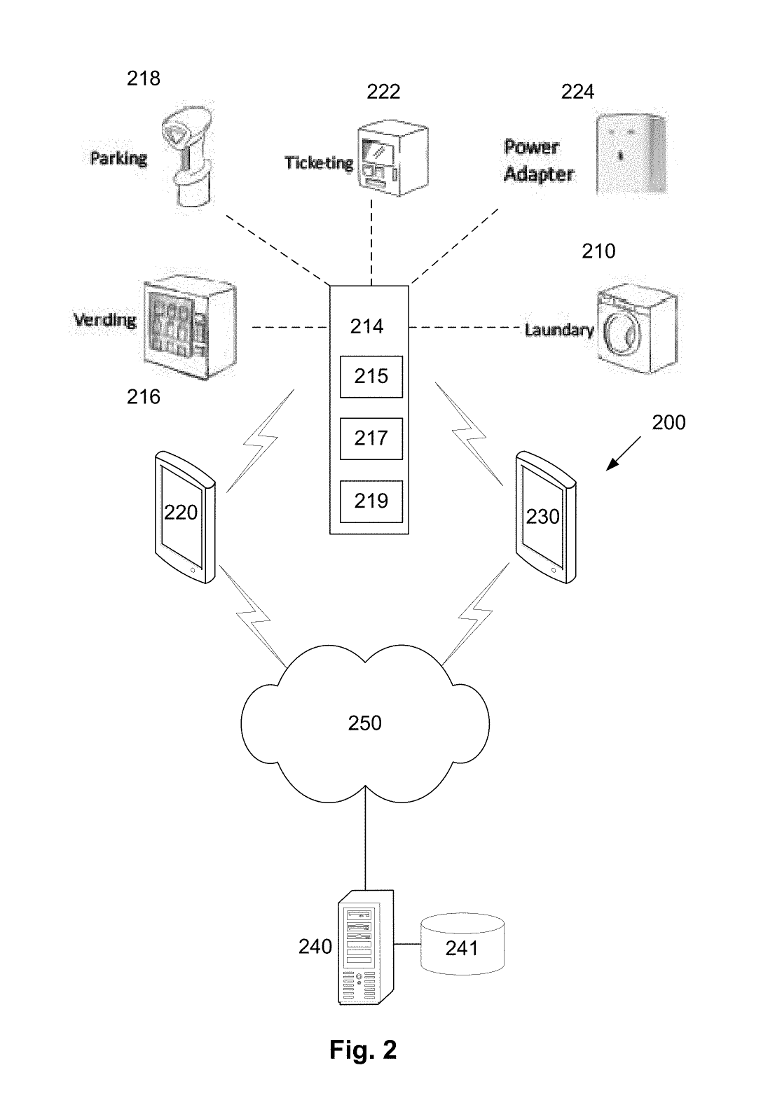

An example of a system for making payment to activate a mode of a service station will now be described with reference to FIG. 2.

In this example, the system 200 includes an authentication device 214 in communication with any of the service stations, for example, a washing machine 210, a power adaptor 224, a ticketing machine 222, a parking metre 218, and a vending machine 216. The authentication device 214 is further in communication with one or more user devices 220 optionally running a payment application and one or more merchant devices 230 optionally running a merchant application. The user and merchant devices 220, 230 are in communication with a payment system 240 via a communications network 250. The payment system 240 may be in communication with a database 241.

The communications network 250 can be of any appropriate form, such as the Internet and/or a number of local area networks (LANs). It will be appreciated that the configuration shown in FIG. 2 is for the purpose of example only, and in practice the user devices 220, merchant devices 230, authentication device 214 and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the one or more user and merchant devices 220, 230 communicate with the authentication device 214 via a wireless communication protocol such as Bluetooth, Wi-Fi Zigbee, or through Near Field Communication (NFC) but not limited to such. The user and merchant devices 220, 230 may typically communicate with the payment system over a mobile network or via the Internet.

User Device 220 and Merchant Device 230

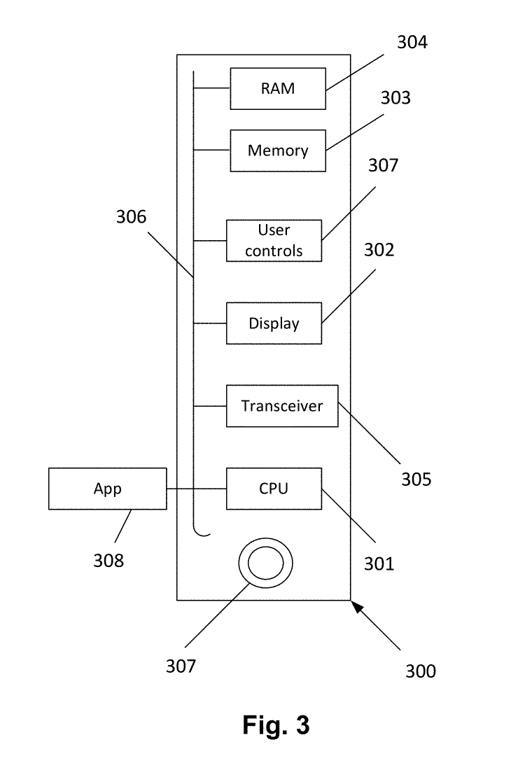

The user device 220 and merchant device 240 of any of the examples herein may be a handheld computer device such as a smart phone or a PDA such as one manufactured by Apple™, LG™, HTC™, Research In Motion™, or Motorola™. The user device 220 or merchant device 230 may include a mobile computer such as a tablet computer. An exemplary embodiment of a user device 300 is shown in FIG. 3. As shown, the device 300 includes the following components in electronic communication via a bus 306:

1. a display 302;

2. non-volatile memory 303;

3. random access memory (“RAM”) 304;

4. N processing components 301;

5. a transceiver component 305 that includes N transceivers; and

6. user controls 307.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 302 generally operates to provide a presentation of content to a user, and may be realized by any of a variety of displays (e.g., CRT, LCD, HDMI, micro-projector and OLED displays). And in general, the non-volatile memory 303 functions to store (e.g., persistently store) data and executable code including code that is associated with the functional components of a browser component and applications, and in one example, a payment application 308 executing on the user device 220 and a merchant application executing on the merchant device 230. In some embodiments, for example, the non-volatile memory 303 includes bootloader code, modem software, operating system code, file system code, and code to facilitate the implementation of one or more portions of the payment application 308 as well as other components well known to those of ordinary skill in the art that are not depicted for simplicity.

In many implementations, the non-volatile memory 303 is realized by flash memory (e.g., NAND or ONENAND memory), but it is certainly contemplated that other memory types may be utilized as well. Although it may be possible to execute the code from the non-volatile memory 303, the executable code in the non-volatile memory 303 is typically loaded into RAM 304 and executed by one or more of the N processing components 301.

The N processing components 301 in connection with RAM 304 generally operate to execute the instructions stored in non-volatile memory 303 to effectuate the functional components. As one of ordinarily skill in the art will appreciate, the N processing components 301 may include a video processor, modem processor, DSP, graphics processing unit (GPU), and other processing components.

The transceiver component 305 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Authentication Device 214

A suitable authentication device 214 for use in the system 200 is shown in FIG. 2.

In this example, the authentication device 214 includes at least one microprocessor 215, a memory 217 and an external interface 219 interconnected via a bus. In this example the external interface 219 can be utilised by the authentication device 214 when communicating with peripheral devices, such as the user and merchant devices 220, 230 Although only a single interface 216 is shown, this is for the purpose of example only, and in practice multiple interfaces using various methods (e.g. Ethernet, serial, USB, wireless, Bluetooth™ Low Energy (BLE), Near Field Communication (NFC), or the like) may be provided.

In use, the microprocessor 215 executes instructions in the form of applications software stored in the memory 217 to allow communication with the user device 220, for example to provide a service token and receive a payment token therefrom, and the merchant device 230, for example to provide the initialization data packet and receive the provisioning data. The applications software may include one or more software modules, and may be executed in a suitable execution environment, such as an operating system environment, or the like.

Accordingly, it will be appreciated that the authentication device 214 may include any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the authentication device 214 is a standard processing system such as an Intel Architecture based processing system, which executes software applications stored on non-volatile (e.g., hard disk) storage, although this is not essential.

Payment System 240

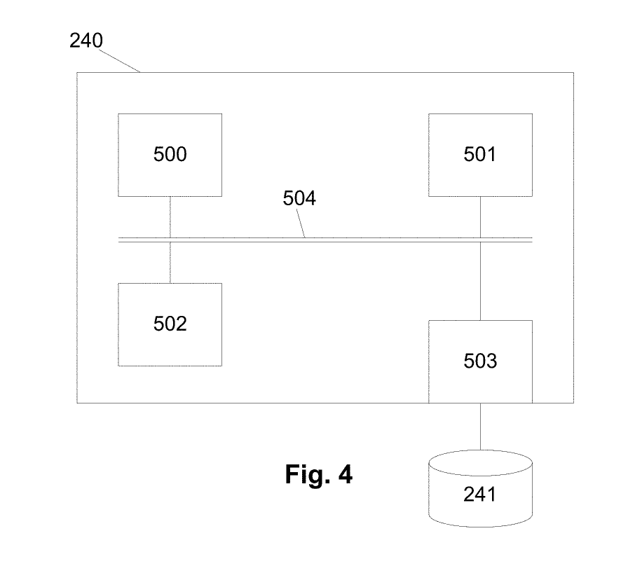

A suitable payment system 240 for use in the system described in anyone of the above examples is shown in FIG. 4.

In this example, the payment system 240 is a server that includes at least one microprocessor 500, a memory 501, an optional input/output device 502, such as a display, keyboard, touchscreen and the like, and an external interface 503, interconnected via a bus 504 as shown. In this example the external interface 503 can be utilised for connecting the payment server 240 to peripheral devices, such as user and merchant devices 220, 230, the communication networks 250, databases 241, other storage devices, or the like. Although a single external interface 503 is shown, this is for the purpose of example only, and in practice multiple interfaces using various methods (e.g. Ethernet, serial, USB, wireless or the like) may be provided.

In use, the microprocessor 500 executes instructions in the form of applications software stored in the memory 501 to allow communication with the user device 220, for example to receive a service token and to provide payment options, and the merchant device 230, for example to receive the registered initialization token and to provide provisioning data. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the payment system 240 may also be formed from a suitably programmed PC, Internet terminal, lap-top, or hand-held PC, a tablet, or smart phone, or the like. Thus, in one example, the payment system 240 is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example as will be well understood in the art, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

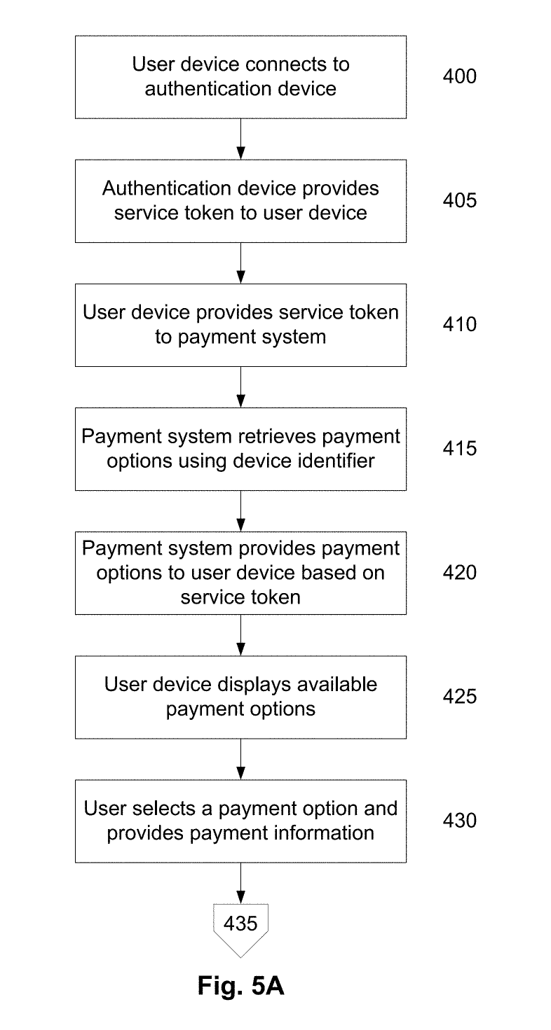

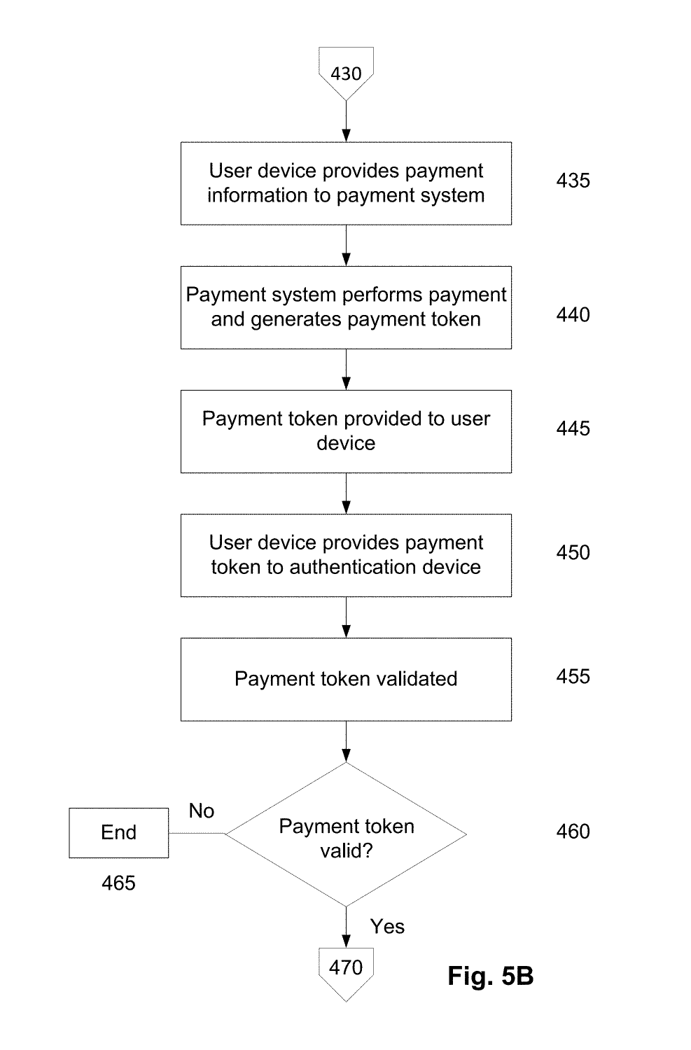

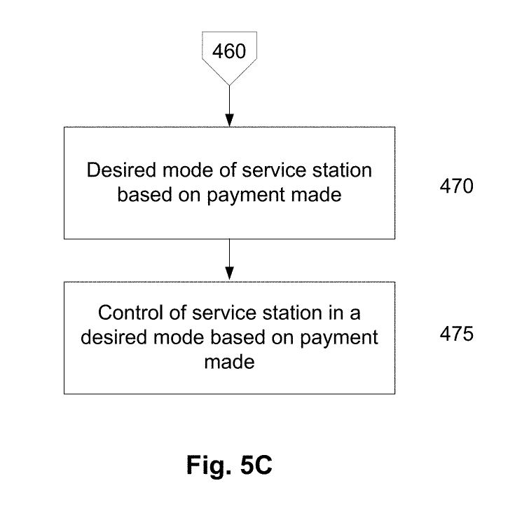

To illustrate further features of preferred practical implementations of the method, a further detailed example of a method for making payment to activate a mode of a service station will now be described with reference to FIGS. 5A-5C.

At step 400, a user connects or pairs their user device to an authentication device, for example through Bluetooth connectivity, Zigbee, Wi-Fi or any other suitable wireless communications protocol. Once a connection has been established, the authentication device provides a service token to the user device at step 405. The service token is indicative of one or more pre-selected payment options associated with activating a mode of the service station, and/or also associated with a service session established between the user device and the service station. The user device then provides the service token to a payment system, such as a payment server at step 410. The user device may provide the service token to the payment system in accordance with instructions provided by the user through a payment application executing on their device or other suitable interface. In one example, the service token could be sent from the user device via a text message to the payment server.

At step 415, the payment system retrieves payment options (pre-selected by a merchant/owner/operator) from a data store using the service token which will typically be associated with a device identifier such as a unique device key. In this way, payment options applicable for a particular service station can be linked to the authentication device using the service token and device identifier. At step 420, the payment system provides the payment options to the user device based on the service token. The available payment options are then displayed on a user interface of the user device including for example an interface provided by a payment application at step 425.

At step 430, the user selects a suitable payment option and provides payment information. This may be done through a digital wallet or alternatively the user may enter their bank account or card details as would typically occur in a standard e-commerce transaction with a merchant/owner/operator. The payment information is provided by the user device to the payment system at step 435.

At step 440, the payment system performs the payment and generates a payment token which will be indicative of the payment option selected by the user and be associated with the device identifier for the purposes of validation. The payment system may perform the payment in accordance with standard payment processing techniques involving an acquirer, card network, and issuer and optionally a payment gateway.

At step 445, the payment token is provided to the user device via the communications network (e.g. mobile network, Internet etc.). At step 450, the user device then provides the payment token to the authentication device in accordance with an instruction from the user to do so. The payment token may then be validated using at least one of, for example, the unique device identifier, decrypted using a unique key, verification of a digital signature generated from the payment system, and determination of whether the payment token is for the particular service station at step 455 to ensure that the correct device has received the payment token and that the payment option selected is valid for the particular service station.

At step 460, the authentication device determines whether the payment token is valid. If it is found to not be valid then the process ends at step 465. Otherwise, the process proceeds to step 470 where the authentication device determines a desired mode of the service station based on the payment made (for example, e.g. $1:00 to park a vehicle for 5 minutes, $2:00 to park a vehicle for 10 minutes etc.). Finally, at step 475 the authentication device is configured to control the service station in the desired mode in accordance with the payment option selected by the user.

Accordingly, it will be appreciated that in at least one example the above described methods and system may enable electrical appliances to be used on a ‘pay be use’ basis without requiring traditional forms of payment such as physical money (coins, notes) and bank cards. The ability to restrict usage of appliances in accordance with specific payment options (for example based on duration of use) may also make users more conscious of their energy usage which may lead to reduced energy consumption and more considered decision making around use of appliances. Furthermore, the ability to simply pay for use of appliances may additionally create a new revenue stream for accommodation providers who traditionally rent out rooms having several appliances available for use by their guests.

Whilst there have been described in the foregoing description preferred embodiments of the present invention, it will be understood by those skilled in the technology concerned that many variations or modifications in details of design or construction may be made without departing from the present invention.

1. A data processor implemented method for making payment to activate a mode of a service station, the method including, in one or more electronic processing devices:
providing, to a user device, a service token, the service token being at least one of: indicative of one or more pre-determined payment options associated with a plurality of activation modes of the service station, and associated with a service session established between the user device and the service station;
providing, from the user device, the service token to a payment system via a communications network;
receiving, from the payment system, an indication of the payment options associated with the service token;
providing, from the user device, payment information to the payment system in accordance with a payment option selected by the user;
receiving, at the user device, a payment token from the payment system in response to successful payment using the payment information;
receiving, from the user device, the payment token; and,
using the payment token to activate the mode of the service station in accordance with the payment option selected by the user.

2. The method according to claim 1, wherein each of the plurality of activation modes is a different payment quantum.

3. The method according to claim 1, wherein the one or more electronic processing devices communicates with the user device via a wireless communications protocol.

4. The method according to claim 3, wherein the wireless communications protocol includes Bluetooth™ Low Energy (BLE) protocol.

5. The method according to claim 1, further including validating the payment token using a device identifier.

6. The method according to claim 5, wherein the step of validating the payment token includes at least one of:
decrypting the payment token using a unique key;
using the device identifier to determine that the payment token has been received for an intended service station;
verifying a digital signature generated by the payment system for the intended service station;
determining that the payment token is for the established service session between the user device and the intended service station; and
determining that the payment option selected by the user is valid for the intended service station.

7. A system for making payment to activate a mode of a service station, the system including one or more electronic processing devices that:
provides, to a user device, a service token, the service token being at least one of: indicative of one or more pre-determined payment options associated with a plurality of activation modes of the service station, and associated with a service session established between the user device and the service station;
provides, from the user device, the service token to a payment system via a communications network;
receives, from the payment system, an indication of the payment options associated with the service token;
provides, from the user device, payment information to the payment system in accordance with a payment option selected by the user;
receives, at the user device, a payment token from the payment system in response to successful payment using the payment information;
receives, from the user device, the payment token; and,
uses the payment token to activate the mode of the service station in accordance with the payment option selected by the user.

8. The system according to claim 7, wherein each of the plurality of activation modes is a different payment quantum.

9. The system according to claim 7, wherein the one or more electronic processing devices communicates with the user device via a wireless communications protocol.

10. The system according to claim 9, wherein the wireless communications protocol includes Bluetooth™ Low Energy (BLE) protocol.

11. The system according to claim 7, the one or more electronic processing devices also validates the payment token using a device identifier.

12. The system according to claim 11, wherein the validation of the payment token includes at least one of:
decryption of the payment token using a unique key;
use of the device identifier to determine that the payment token has been received for an intended service station;
verification of a digital signature generated by the payment system for the intended service station;
determination that the payment token is for the established service session between the user device and the intended service station; and
determination of the payment option selected by the user is valid for the intended service station.

13. A non-transitory computer readable storage medium embodying thereon a program of computer readable instructions which, when executed by one or more processors of a user device in communication with at least one payment system and an authentication device, cause the user device to perform a method for making payment to activate a mode of a service station, the method embodying the steps of:
providing, to the user device, a service token, the service token being at least one of: indicative of one or more pre-determined payment options associated with a plurality of activation modes of the service station, and associated with a service session established between the user device and the service station;
providing, from the user device, the service token to a payment system via a communications network;
receiving, from the payment system, an indication of the payment options associated with the service token;
providing, from the user device, payment information to the payment system in accordance with a payment option selected by the user;
receiving, at the user device, a payment token from the payment system in response to successful payment using the payment information;
providing, from the user device, the payment token; and,
using the payment token to activate the mode of the service station in accordance with the payment option selected by the user.

14. The storage medium according to claim 13, wherein each of the plurality of activation modes is a different payment quantum.

15. The storage medium according to claim 13, wherein the one or more electronic processing devices communicates with the user device via a wireless communications protocol.

16. The storage medium according to claim 15, wherein the wireless communications protocol includes Bluetooth™ Low Energy (BLE) protocol.

17. The storage medium according to claim 13, further embodied in a step of validating the payment token using a device identifier.

18. The storage medium according to claim 17, wherein the step of validating the payment token includes at least one of:
decrypting the payment token using a unique key;
using the device identifier to determine that the payment token has been received for an intended service station;
verifying a digital signature generated by the payment system for the intended service station;
determining that the payment token is for the established service session between the user device and the intended service station; and
determining that the payment option selected by the user is valid for the intended service station.
